(19) United States
(12) Patent Application Publication
(10) Pub. No.: US 2005/0075591 A1
(43) Pub. Date: Apr. 7, 2005

(54) Massage attachment for a motor-driven foot care apparatus

(76) Inventor: Klaus Hafemann, Essen (DE)

Correspondence Address: RICK MARTIN;PATENT LAW OFFICES OF RICK MARTIN, PC, 416 COFFMAN STREET, LONGMONT, CO, 80501, US

(21) Appl. No.: 10/346,127

(22) Filed: Jan. 16, 2003

(30) Foreign Application Priority Data
Jan. 19, 2002 (DE) 202 00790.1

(51) Int. Cl. A61H 15/00

(52) U.S. Cl. 601/113; 601/128

(57) ABSTRACT

A massage attachment for a motor-driven foot care apparatus have a coupling piece 2, with which the massage attachment 1 can be attached onto a driving shaft of the foot care apparatus. The massage attachment also has several movably disposed massage elements M with spherical physical appearance and is the spherical massage elements M are each born rotatably on an axle S extending in a direction having a vectorially radial component.

### CROSS REFERENCE APPLICATIONS

This application claims priority from German application no. 202 00790.1 filed Jan. 19, 2002.

### FIELD OF INVENTION

The present invention relates to a massage attachment for a motor-driven foot care apparatus with a coupling piece to attach onto a driving shaft of the foot care apparatus, as well as several movably disposed massage elements with spherical physical appearance.

### BACKGROUND OF THE INVENTION

Foot care devices that are part of a foot tub and foot massage device are known in the art. The tub bottom of the foot bath can be made to vibrate for massaging the soles of the feet. The foot tub is divided into two areas by a ridge for receiving one foot in each area. A motor-driven foot care apparatus is integrated in the ridge. The rotationally driven driving shaft of the foot care apparatus projects at the top from the ridge and carries a first coupling piece. Different attachments for foot care and/or foot massage can be attached onto the driving shaft with its end-terminal coupling piece.

A known massage attachment has a coupling piece which makes a torsion-tight connection between the driving shaft and the massage attachment. The massage attachment is developed at the top as a ball bearing cage with several spherical massage elements, or massage balls. The massage balls are disposed in one plane such that they are movable. The massage elements themselves remain stationary and can rotate in all directions in their cage. The massage balls project a portion of their surface from the top of the cage. This means that the effective massage depth is defined by the projection of the massage balls from the upper cage shell. Such a foot care apparatus is known for example from DE 295 02 720 U1.

Such a massage attachment conventionally comprises several massage rollers, which are distributed uniformly over the surface of the massage attachment. The individual massage balls project by only a few millimeters from the upper shell of the ball bearing cage. During the operation the massage attachment rotates and a foot massage occurs due to the rotational movement of the massage balls. Under unfavorable conditions it is possible for skin to be pulled into the bearing gap between the surface of a massage ball and the upper cage shell through the rotational movement of the massage balls. This can be painful; it is, in any event, undesirable.

Building on this discussed prior art the invention therefore addresses the problem of further developing a massage attachment such that the disadvantages entailed in prior art are avoided.

### SUMMARY OF THE INVENTION

The primary aspect of the present invention is to provide a massage attachment with a reduced chance of skin trapping.

Other aspects of this invention will appear from the following description and appended claims, reference being made to the accompanying drawings forming a part of this specification wherein like reference characters designate corresponding parts in the several views.

This problem is solved by having the spherical massage elements each rotatably supported on an axle extending in a direction comprising a vectorially radial component.

In the case of the present invention the spherical massage elements are not supported, as is the case in prior art, in a ball bearing cage and consequently over its surface, but rather on an axle. The axle on which at least one spherical massage element is disposed has in its extension a vectorially radial component. Such an axle can extend, for example, radially with respect to the provided axis of rotation.

In the present invention the massage attachments individual spherical massage elements are supported by a shaft insert into which the axle of the massage attachment engages and which is thus supported internally. This means that the distance of the effective surface of the massage elements from the bearing is spaced so far apart that there is no danger that skin of the foot to be massaged being near the bearing. Moreover, in the present massage attachment, even at high massage pressures at which foot regions could potentially approach up to the axle, there is no danger that skin can be pulled into the movement gap between the rotating massage element and the axle, since a gripping effect is not given, as is the case within prior art.

A further advantage of such a bearing of the employed massage elements is that the massage elements can be developed to be much larger than in prior art. In particular, the massage elements can be developed such that they extend beyond the support margin so that it is also possible to massage the foot utilizing the different rotational behavior of different area of the massage element during a rotation of the massage attachment.

The axles for the mounting of the individual massage elements can be disposed emanating from a central core bar. This central core bar serves simultaneously as a filler element for filling out a portion of the interspace between the individual massage elements. Filler elements can further be disposed between massage elements in each instance. The height of the filler elements also determines the effective massage depth.

It is advantageous to use plug-in axles on which the individual spherical massage elements are supported. The free end of the plug-in axle is located within the massage elements, so that the massage elements project beyond the free end of the plug-in axle.

### BRIEF DESCRIPTION OF THE DRAWINGS

FIG. 1 is a schematic side view of a massage attachment.

FIG. 2 is a top view of the massage attachment of FIG. 1.

FIG. 3 is a section through the massage attachment along line A-B of FIG. 2.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

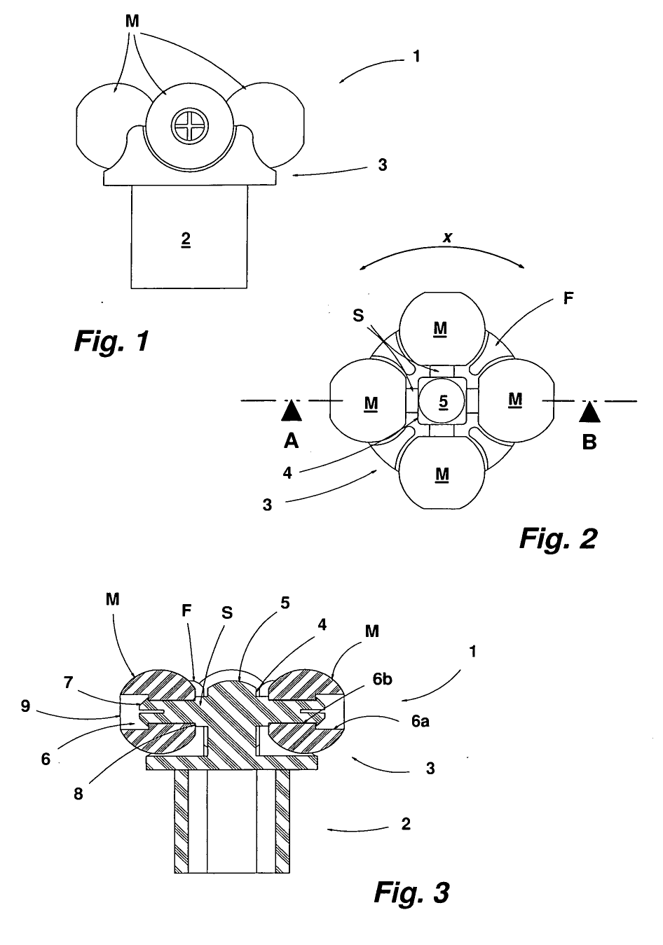

Referring first to FIG. 1, a massage attachment 1 has a coupling piece 2, with which the massage attachment 1 can be attached torsion-tight onto the free end of a driving shaft of a foot care apparatus, not shown in the Figures. The massage attachment 1 is set into rotation during operation of the foot care apparatus as shown by arrow X in FIG. 2. The rotation can be in a single direction or oscillatory.

A roller support 3 is positioned on top of the coupling piece 2, and supports the massage rollers M, as shown in FIG. 1. In the embodiment example depicted, there are four massage rollers M, more or less massage rollers M are possible. The roller support 3, as shown in FIG. 2, has a central core bar 4 with a surface 5 curved at the top side.

Core bar 4 has four plug-in axles S placed such that they project radially outwardly, in the depicted example. The number of plug-in axles would match the number of massage rollers M. The plug-in axles S serve for mounting and bearing the individual massage rollers M. Consequently the massage rollers M are rotatable about their plug-in axles S. Between two massage rollers M can be disposed a filler element F as a portion of the roller support 3. Through the filler elements F the massage rollers M are largely enclosed in their lower region, as shown in FIG. 1.

In the depicted embodiment example the massage rollers M are mounted form-fittingly on a given plug-in axle S, as is shown in FIG. 3. To allow mounting the massage rollers M on a plug-in axles S each massage roller M has a through channel 6 with two areas, 6a and 6b, with two different diameters.

The plug-in axles S have at the ends a mushroom-like thickening Sa and a narrowing directed outwardly. The plug-in axles S have slotted development on their ends forming fingers 7. These fingers 7 can be moved toward one another such that the mushroom-like thickening Sa can be guided through the portion of the through channel 6 with the smaller diameter of a massage roller M, allowing the massage roller M to be mounted on plug-in axles S.

The length of the section having the smaller diameter 6b of the through channel 6 of the massage rollers M corresponds to the bearing length provided by a plug-in axle S, which, in the direction toward the central core bar 4, is delimited by a stop 8. Consequently each massage roller M on the bearing segment of the plug-in axles S is fixed in the axial direction of the plug-in axle S. The front opening 9 of the through channel 6 can be closed with a cap, not shown.

The coupling piece 2 of the massage attachment 1 is developed hexagonally at the inside to rotationally engage the free end of a driving shaft. If the end of the driving shaft had a different shape, then the inside of coupling piece 2 would be shaped accordingly.

A special characteristic of the embodiment example depicted in the Figures is that the individual massage rollers M are developed to extend beyond the margin of the roller support 3 such that not only the upper sides of the massage rollers M can be utilized for massaging but also their radial sections.

In the depicted embodiment example the massage rollers M are supported centrally. Nevertheless, it is also possible to provide that the plug-in axles are born eccentrically in the massage rollers or in other spherical massage elements in order to make possible in this way during the massaging also a vertical massage movement of individual massage elements.

Although the present invention has been described with reference to preferred embodiments, numerous modifications and variations can be made and still the result will come within the scope of the invention. No limitation with respect to the specific embodiments disclosed herein is intended or should be inferred. Each apparatus embodiment described herein has numerous equivalents.

### List of Reference Symbols

1 massage attachment
2 coupling piece
3 roller support
4 core bar
5 surface
6 through channel
6a, 6b subsections of through channel
7 finger
8 stop
9 opening
F filler element
M massage roller
S plug-in axle.

1. Massage attachment for a motor-driven foot care apparatus having a rotational direction of movement, said massage attachment comprising:
a coupling piece with which the massage attachment can be removably attached onto a driving shaft of the foot care apparatus;
a central core bar connected to the coupling piece;
a plurality of massage elements, each with a generally spherical physical appearance;
the spherical massage elements each being rotatably mounted on plug-in axle extending in a radial direction from the central core bar; and
wherein the maximum diameter of the massage attachment is defined by two diametrically opposed massage element pairs.

2. The massage attachment as claimed in claim 1, wherein the axles for the bearing of the massage elements are disposed such that they extend radially with respect to the provided rotational direction of the massage attachment driven by the foot care apparatus.

3. The massage attachment as claimed in claim 1 or 2, wherein the axles further comprise plug-in axles emanating from the central core bar.

4. The massage attachment as claimed in claims 31 or 2, wherein the spherical massage elements in the direction of the extension of their particular plug-in axle project beyond a free end of the plug-in axle.

5. The massage attachment as claimed in claim 4, wherein the maximum diameter of the massage attachment is defined by two diametrically opposed massage element pairs.

6. The massage attachment as claimed in one of claims 1 or 2, wherein the massage attachment comprises at least four spherical massage elements.

7. The massage attachment as claimed in claim 3, wherein the massage attachment comprises at least four spherical massage elements.

8. The massage attachment as claimed in claim 4, wherein the massage attachment comprises at least four spherical massage elements.

9. The massage attachment as claimed in claim 5, wherein the massage attachment comprises at least four spherical massage elements.

10. The massage attachment as claimed in one of claims 1 or 2, wherein in the interspace between each two massage elements filler elements are disposed adapted to the contour of the massage elements.
